(19) United States
(12) Patent Application Publication
(10) Pub. No.: US 2004/0076726 A1
(43) Pub. Date: Apr. 22, 2004

(54) Apparatus and process for continuous pressurized conditioner system

(75) Inventor: Richard V. Lucas, Jordan, MN (US)

Correspondence Address: VIDAS, ARRETT & STEINKRAUS, P.A., 6109 BLUE CIRCLE DRIVE, SUITE 2000, MINNETONKA, MN, 55343-9185, US

(73) Assignee: Scott Equipment Company, New Prague, MN

(21) Appl. No.: 10/611,241

(22) Filed: Jun. 30, 2003

Related U.S. Application Data
(60) Provisional application No. 60/419,616, filed on Oct. 18, 2002.

(51) Int. Cl. A23L 1/00

(52) U.S. Cl. 426/510; 99/330; 99/353

(57) ABSTRACT

A feed pelletizing system having a conditioner having a plurality of high speed rotating paddles, steam, heat, moisture, and pressure which gelatinizes starch for improving the quality of feed pellets. The system includes a mixer/feeder, a first tube feeder, the conditioner, a second pressurized tube feeder, a discharge block connected to a pressurized cylinder, a lump breaker and a pelletizer. Steam and retention processing procedures during feed preparation within the pressurized conditioner may be used in substitution for the known processing techniques of shear and friction during the feed pelletization process.

### CROSS REFERENCE TO RELATED APPLICATION(S)

This application is a utility application which is based upon and which claims priority to, and the benefit of, co-pending provisional patent application Serial No. 60/419,616 filed Oct. 18, 2002, the entire contents of which is incorporated herein by reference in its entirety.

The present invention is also related to the HIGH SPEED GRINDING APPARATUS as disclosed in U.S. Pat. No. 5,887,808; PARTICULATE CAPTURE SYSTEM AND METHOD OF USE as disclosed in U.S. Pat. No. 6,248,156; and MEAL COOLER CENTRIFUGAL SEPARATOR U.S. patent application Ser. No. 09/804,180 as filed Mar. 21, 2001 the entire contents of which are incorporated herein by reference in their entireties.

### BACKGROUND OF THE INVENTION

1. Field of the Invention

This invention relates to a continuous pressurized conditioner apparatus which in combination with other processing equipment forms a system providing a unique manufacturing process for the pelletization of feed which may include corn. More particularly, the present invention relates to a process and apparatus which facilitates efficient preparation of feed where the composition of corn may equal or exceed 50% of the feed material for pelletizing. The process. and apparatus described herein may also be used to efficiently pelletize feed formed of other ingredients and is not restricted to the processing of feed including corn. The process and apparatus efficiently prepares feed for pelletizing by gelatinizing a significant portion of the starch of the corn or other ingredients under controlled pressure, temperature, and humidity conditions. The gelatinization of the starch within the feed pellets is important to facilitate digestion following consumption by an animal or fowl, such as a turkey or a duck, and to promote pellet quality. In addition, the continuous pressurized conditioner apparatus and system sterilizes the feed reducing risk of salmonella and/or other undesirable pathogens for exposure to the animal or fowl.

The time required for processing of the raw feed formed of corn is regulated by the size of the pressurized conditioner, the positioning of the retention paddles and the rotation of the paddles per minute within the pressurized conditioner. Steam and water may be injected into the conditioner to increase the pressure and heat exposed to the product. The moisture level for the feed product exiting the pressurized conditioner apparatus and system may be relatively easily regulated and is preferably between 12% and 20%.

1. Description of the Related Art

Feed pelletizing processes have been known for many years. The feed pelletizing techniques as known have not adequately gelatinized corn starch, or starch from other ingredients, to maximize feed quality. In addition, the feed pelletizing techniques as known have not improved feed quality, due to the failure of the processing techniques to adequately control the temperature and moisture levels for the processed feed. The known pelletizing processes have permitted the feed to cool, and to evaporate moisture during processing, which has resulted in a significant increase in the relative percentage of fines and the degradation in the quality of the processed feed. Further, the undesirable cooling and evaporation of moisture from the processed feed reduces pellet durability resulting in significant waste of resources and funds.

The feed pelletizing techniques and equipment as known have also not maximized equipment efficiency and longevity during the pellet formation process. The continuous pressurized conditioner apparatus and system described herein utilizes a fraction of the power as required by conventional expander. The economical utilization of power and the maximization of the useful life of equipment occurs through the use of steam and retention processing procedures during feed preparation within the pressurized conditioner, in substitution for the known processing techniques of shear and friction during the feed pelletization process. The feed processing techniques described herein also reduce the direct handling of the product, minimizing environmental condensation of moisture and the exposure of the product to contamination, which deprives pathogens of a warm moist environment for bacterial growth, thereby improving sterilization and minimizing odor during processing efforts.

In view of the foregoing it is clear that a continuous pressurized conditioner apparatus and system is needed having the capability to efficiently and effectively gelatinize a desired portion of the starch of feed formed of corn or other ingredients under controlled pressure, temperature, and humidity conditions.

### BRIEF DESCRIPTION OF THE INVENTION

In view of the above, the present invention is directed to a combination of apparatus and processing equipment into a system which may be used to provide a manufacturing process to enhance the quality of feed pellets for consumption by animals and/or fowl.

The present invention provides for a unique conditioner, incorporating a steam and water blending chamber, which may be utilized within a processing system in conjunction with other equipment/apparatus such as a mixer/feeder, pressurized tube feeders or screws, lump breakers, and /or pelletizers.

Generally, a hopper or a mixer/feeder which includes a hopper may be utilized to receive raw feed material formed of corn or other ingredients including starch. The raw feed material is then fed into a first tube feeder and/or screw for the simultaneous transportation of the feed to a first outlet and the creation of a first plug of crumbling material. The first plug of crumbling feed assists to prohibit reverse air flow passage, or to create a reverse air flow block, to facilitate the retention of pressure within the system. Crumbling feed from the first plug of material enters the inlet for the conditioner for exposure to rotating paddles, increased pressure, liquid, steam, and/or heat for gelatinization of the starch and the processing of the raw feed material. The feed is exposed to the rotating paddles, a desired level of heat, pressure, steam and/or moisture for a desired period of time whereupon the rotation of the paddles transfers the now processed feed material including the gelatinized starch to the conditioner outlet. From the conditioner outlet the feed enters a second pressurized tube feeder and/or screw for transportation to a second outlet whereupon a second plug of crumbling feed is formed. The second plug of crumbling feed is formed due to the positioning of a discharge block proximate to the second outlet for the second pressurized tube feeder and/or screw. The discharge block is preferably connected to a pressurized cylinder. Processed feed is permitted to pass the discharge block when the pressure on the second plug, as created by the continued accumulation of processed feed on the upstream side of the second plug, from continuous operation of the second tube feeder, exceeds the blocking pressure as established by the pressurized cylinder, whereupon the outward pressure of the second plug of feed forces the discharge block outwardly from the second outlet, which compresses the pressurized cylinder, permitting processed feed to pass the discharge block into a lump breaker and then into a pelletizer for pelletizing.

The present invention may be embodied in a variety of unique systems and apparatus such as those described in detail below. The invention may be retrofitted to an existing system or may be included in new processor designs as well.

### BRIEF DESCRIPTION OF THE SEVERAL VIEWS OF THE DRAWINGS

A detailed description of the invention is hereafter described with specific reference being made to the drawings in which:

FIG. 1 is a diagrammatic representation of one embodiment of the continuous pressurized conditioner;

FIG. 2 is a detail cut-away side view of one embodiment of the first tube feeder;

FIG. 3 is a detail end view of one embodiment of a rotatable shaft and paddle assembly;

FIGS. 4A-4D are alternative views of an embodiment of a rotatable shaft and paddle assembly;

FIG. 5 is an end view of an embodiment of the continuous pressurized conditioner;

FIG. 6 is a detail partially cut-away side view of one embodiment of the continuous pressurized conditioner;

FIG. 7 is a partial cut-away detailed side view of a portion of the invention illustrating the operation of the tapered cone/discharge block.

### DETAILED DESCRIPTION OF THE PREFERRED EMBODIMENTS

As indicated above the present invention is directed to a combination of apparatus and processing equipment into a system which may be used to provide a manufacturing methodology to enhance the quality of feed pellets for consumption by animals and/or fowl. The present invention is also related to the HIGH SPEED GRINDING APPARATUS as disclosed in U.S. Pat. No. 5,887,808; PARTICULATE CAPTURE SYSTEM AND METHOD OF USE as disclosed in U.S. Pat. No. 6,248,156; and MEAL COOLER CENTRIFUGAL SEPARATOR U.S. Patent application Ser. No. 09/804,180 as filed Mar. 12, 2001 the entire contents all of which are incorporated herein by reference in their entireties.

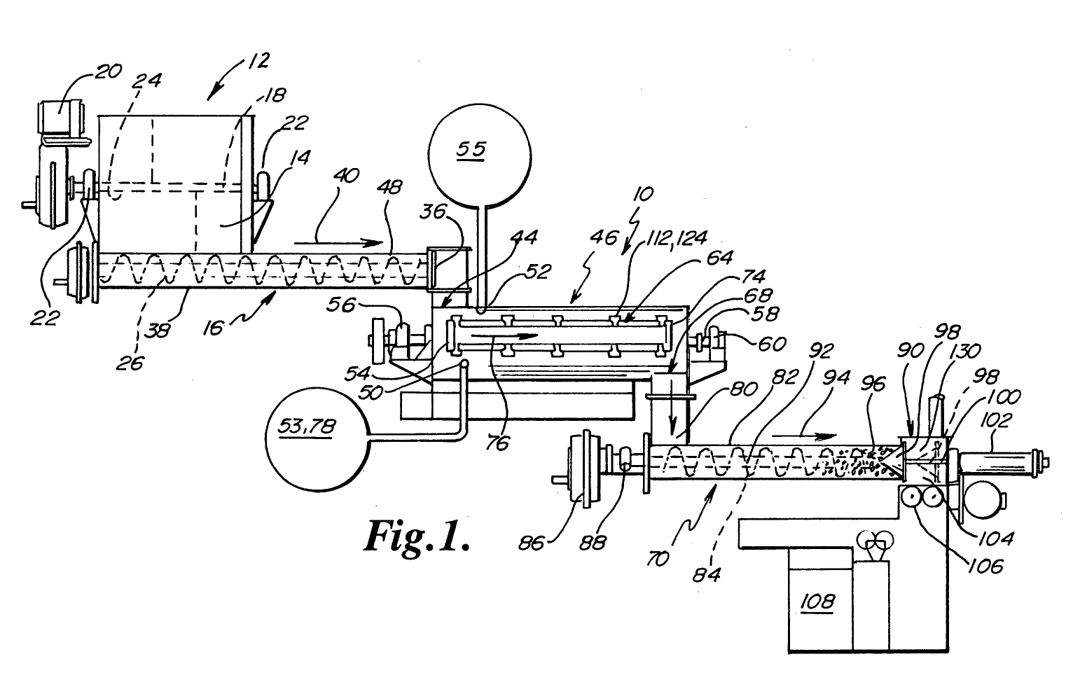

Turning to FIG. 1, a Continuous Pressurized Conditioner System 10, is shown which employs an embodiment of a mixer/feeder 12; first tube feeder 16; conditioner 46; second pressurized tube feeder 70; tapered cone/discharge block 98; lump breaker 106 and pelletizer 108 of the present invention.

As may be seen in FIG. 1 the Apparatus and Process for the Continuous Pressurized Conditioner System 10 may begin with a mixer/feeder 12 which may include a hopper 110, a hopper, or any other type of inlet apparatus for holding unprepared feed 48 which may be formed at least partially of corn. The mixer/feeder 12, hopper, or other apparatus may be positioned above, to the side, at the end, or in feed flow communication with the first tube feeder 16 to charge the pressurized conditioner. The positioning of the inlet into the first tube feeder 16 is primarily dictated by available spatial considerations within a processing facility. In the event that a mixer is utilized then the mixer 12 preferably includes a first shaft 18 which is engaged to a pair of idle first bearings 22. The first shaft 18 is driven by a first motor 20 to rotate first agitation members or paddles 24 as engaged to the first shaft 18. The rotation of the first shaft 18 and first agitation members facilitates the mixing and movement of the raw feed 48 downwardly through the hopper 110 and out of the exit chute 14.

The exit chute 14 is preferably in feed flow communication with the first tube feeder 16 which receives and transfers the raw feed material 48 to the conditioner 46 for processing. The raw feed material 48 is generally at ambient temperature and ambient pressure when entering the first tube feeder 16. At this temperature the raw feed material 48 generally enters the first tube feeder 16 having a moisture content of between 10.5% and 13.5%. In addition, the raw feed material 48 entering the first tube feeder 16 is preferably formed of corn, corn meal, ground corn, fine ground corn, coarse ground corn, and/or partially ground corn, in a percentage of 45% to 80% of the starting raw feed material. In addition, to the utilization of corn as starting raw feed material, ingredients of soy, CCFM, meat, distillers, DICAL, calcium, fat in the mixture, miscellaneous ingredients, and downstream fat may be utilized. In one composition of raw feed material, corn forms 55.73% of the total weight of the raw feed material; soy forms 21.46% of the total weight of the raw feed material; CCFM forms 7.4% of the total weight of the raw feed material; meat forms 3.95% of the total weight of the raw feed material; distillers form 2.45% of the total weight of the raw feed material; DICAL forms 0.95% of the total weight of the raw feed material; calcium forms 0.7% of the total weight of the raw feed material; fat in the mixture forms 1.0% of the total weight of the raw feed material; miscellaneous ingredients form 0.75% of the total weight of the raw feed material; and downstream fat forms 5.6% of the total weight of the raw feed material.

The listed types of material identified herein for the raw feed material 48 are not intended to be restrictive or limited, and other types of starting raw feed material 48 may be utilized dependent upon the animal and/or fowl to consume the processed pelletized feed. Generally the raw feed material 48 includes starch which is gelatinized during the processing steps identified herein to improve the overall quality of the pelletized feed product while simultaneously reducing the percentage of fines.

The first tube feeder 16 may have a length dimension of approximately 5 feet to 10 feet or more. The first tube feeder 16, may be formed of one or more sections to provide a desired length of transition to the conditioner 46. The length of the first tube feeder 16, and positioning of the first tube feeder 16 relative to the mixer 12, and conditioner 46, will be dependent on spatial considerations within a processing facility.

The first tube feeder 16 has a second shaft 26 which is engaged to a second motor 30. The second shaft 26 preferably passes through a single bearing 28 which in turn traverses a second end wall. The first tube feeder 16 has on open discharge end 36. A first auger or screw 38 is integral to, and surrounds the second shaft 26, for compacting movement of the raw feed 48 in the direction of arrow 40. Engagement of the second motor 30 moves unprocessed feed in the direction of arrow 40 to the right. The first auger or screw 38 preferably terminates between 1½ and ½ flights prior to the open discharge end 36. The termination of flights prior to the open discharge end 36 facilitates the formation of the first plug 42 of feed material. The transition of the exit chute 14 into the first tube feeder 16 also facilitates the formation of a cylindrical plug 42 of raw feed material 48 which preferably forms an air seal for the Continuous Pressurized Conditioner System 10. The first collapsing or crumbling plug 42 of feed accumulates proximate to the open discharge end 36 of the first tube feeder 16.

The first plug 42 functions to assist in the establishment of a pressure barrier and a reverse air flow block to minimize loss of pressure from the Continuous Pressurized Conditioner System 10. The first plug 42 is advanced and simultaneously maintained by the continuous build up of particulate raw feed matter behind the advancing first plug 42. By plugging the open discharge end 36 in this manner the Continuous Pressurized Conditioner System 10 maintains a negative pressure air flow without back drafting from the outside air through the first tube feeder 16 and the mixer/feeder 12 or hopper. The raw feed matter 48 which comprises the first plug 42 is preferably continuously pushed to the open discharge end 36 and replaced by raw feed material 48 that follows, thus assuring that no static raw feed material remains in the system. The first plug 42 preferably prevents pressure from exiting the apparatus and system upstream or rearwardly through the first tube feeder 16 and upwardly through the exit chute 14 and mixer 12 or hopper.

The first auger or screw 38 preferably is positioned adjacent to and may be in contact with the interior walls of the first tube feeder 16 to assist in the minimization of pressure loss upstream through the apparatus and/or system. Generally, the second shaft 26 of the first tube feeder 16 is required to rotate faster than the rate of rotation of the first shaft 18 of the mixer/feeder 12 or hopper to prevent clogging. It is desirable to have the second shaft 26 within the first tube feeder 16 rotate at an increased rate as compared to the mixer/feeder 12 or hopper in order to insure that feed material is transported proximate to the open discharge end 36 to assist in the formation of the first plug 42 of raw feed material.

The open discharge end 36 of the first tube feeder 16 is preferably in feed flow communication with the transition inlet 44 into the conditioner 46 permitting particulate matter 48 to be gravity dropped or force fed into the side of the conditioner 46.

The conditioner 46 may be characterized in general as being a substantially hollow, cylindrical shaped structure. In general, the conditioner 46 preferably includes an inlet 44 which is the location for the entry of unprocessed feed 48 into the interior chamber of the conditioner 46. The third shaft 58 preferably extends the length of the conditioner 46. A plurality of third paddles 64 extend outwardly from the third shaft 58. The paddles 64 are used to process and reduce the raw feed material 48 into particulate matter. The rotation of the third shaft 58 and third paddles 64 by the third motor 56 preferably follows the contour of the curve of the inside chamber of the conditioner 46.

During operation, the third motor 56 rotates the third shaft 58 spinning the paddles 64 so as to create a radially acting force on the raw feed material 48. This force causes the raw feed material 48 to be mixed with the steam and ribbon paddle assembly holding the material within the conditioner 46 for approximately one minute. The continued rotation of the third shaft 58 and third paddles 64 in general causes the particulate matter to be directed toward the third exit port 68 as a result of the radially acting force. If any of the particulate matter remains in contact with the inside wall of the conditioner 46, which may occur, the paddles 64 are of sufficient length to “scrape” any accumulating particulate matter off the inside wall for transfer to the third exit port 68. Generally, it is desirable to establish a rate of rotation of the third shaft 58 within the conditioner 46 of sufficient speed to insure that raw feed does not accumulate at the main inlet area 54 which could potentially clog the conditioner 46.

The conditioner 46 is preferably pressurized to a level of 5 to 10 lbs. per square inch. The feed 48 entering the conditioner 46 at this time may be indirectly heated through an attached steam jacketed kettle and/or may be mixed with steam as emitted from a stem inlet port 50, which may occur through steam injection, and which preferably raises the temperature of the feed 48 within the conditioner 46 to approximately 205° F. to 235° F. Generally, the heated, pressurized, and moisturized feed 48 is retained within the conditioner 46 for approximately 1 minute during processing. The moisture content of the feed 48 may also be regulated through the introduction of water through the liquid inlet port 52. Generally, the moisture for the feed 48 is controlled by the steam, at the steam inlet port 50, and water from the liquid inlet port 52 to provide a moisture level of between 14 and 18 percent.

The steam inlet and/or injection port 50 may be in communication with a source of steam 53 through the use of appropriate conduits. The liquid inlet port 52 may additionally be in communication with a reservoir of liquid 55 through the use of appropriate conduits.

Immediately below the transition inlet 44 is located the main inlet area 54 for the conditioner 46. The conditioner 46 also preferably includes a third motor 56 which may be engaged to a third shaft 58. The third shaft 58 is preferably engaged to a third pair of idle bearings 60 which permits rotation of the third shaft 58 within the conditioner 46. The third shaft 58 also preferably includes a plurality of third paddles 64. The third paddles 64 are preferably engaged to paddle supports 74. The paddle supports 74 may be disposed for a 120° separation or offset between adjacent paddles 64 along the third shaft 58 when viewed from the end of the conditioner 46. (FIG. 3.) Alternatively the paddle supports 74 may be disposed for a 90° or a 60° separation between adjacent paddles when viewed from the end of the conditioner 46.

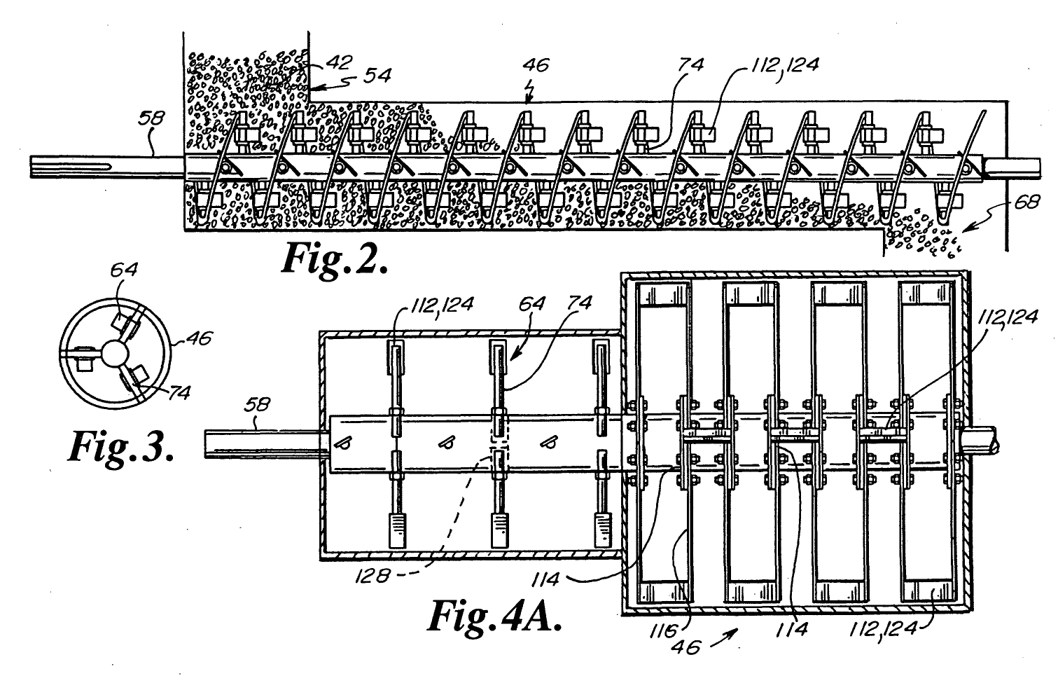

As may be seen in FIG. 2 the paddles faces 112, 124 may be angularly offset relative to the paddle supports 74. The angular offset of the paddles faces 112, 124 relative to each paddle support 74 may be identical or may increase or decrease along the length of the third shaft 58. The angular offset of a paddle face 112, 124 relative to a paddle support 74 may be between 10° and 70° downwardly from vertical in a direction away from the direction for rotation of the shaft 58 and paddles 64. Generally the angular offset of the paddle faces 112, 124 relative to the respective paddle support 74 is fixed, however, the angular offset may be adjustable and altered for use with a particular type or composition of feed material 48.

In general, the paddle faces 112, 124, actively push against air and the feed material during rotation and have a fairly narrow width. The paddle faces 112, 124, may have a width dimension between ½ of an inch to over 6 inches. In one embodiment the paddle faces 112 have a width of ½ an inch. In at least one embodiment, the paddles faces 112 are angularly offset between 10° and 25° degrees relative to the respective paddle support 74 which connects the paddle face 112 to the third shaft 58.

In the case of the conditioner 46, the angled paddle face 112 improves the ability of the third paddles 64 to push particulate 48 outwardly for forcible contact with the interior surface of the chamber and toward the third exit port 68 and inlet port 80 for the second pressurized tube feeder 70. In one embodiment shown, the third paddles 64 may be arranged about the third shaft 58 in an opposingly offset manner. The offset arrangement of the paddles 64 has been found to provide improved air flow and rotational balance as the shaft 58 is rotated. In alternative embodiments the paddles 64 may be arranged in any manner as desired by the user. A detailed description of alternative rotatable air paddles (hammers/beaters) which may be adapted for use with the present conditioner are described in U.S. Pat. No. 5,887,808, entitled High Efficiency Grinding Apparatus, issued Mar. 30, 1999, to Richard V. Lucas. U.S. Pat. No. 5,570,517, entitled Slurry Dryer, issued Nov. 5, 1996, to William A. Luker, assigned to the same assignee as the present invention, also describes paddles or blades on a rotating shaft which may be modified for inclusion in the present invention. Both references are incorporated by reference herein in their entireties.

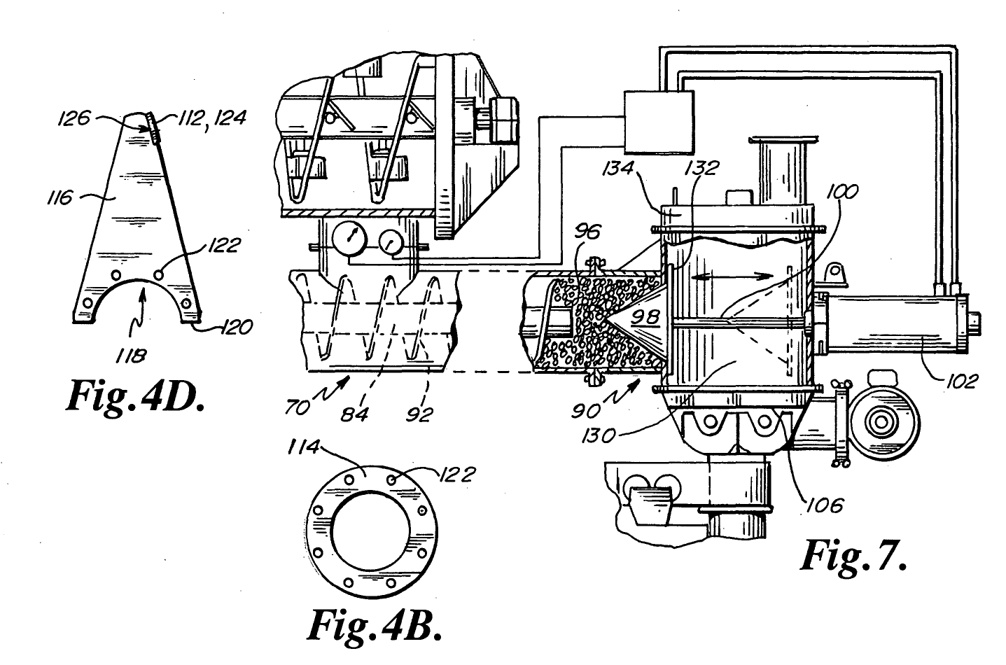

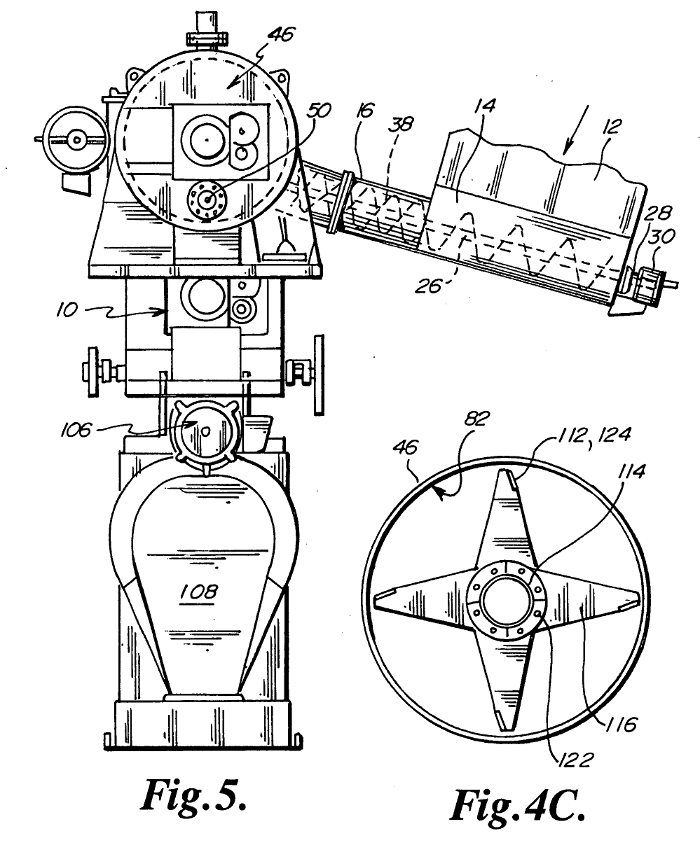

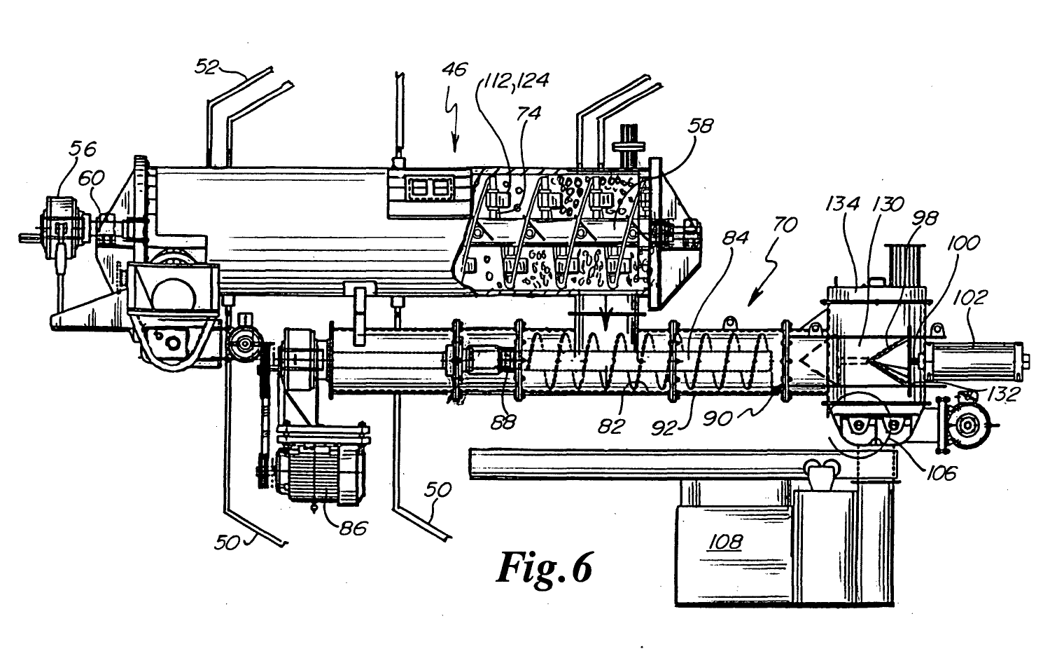

As may be seen in FIGS. 4A-4D, an alternative paddle assembly may be engaged to the shaft 58 within the conditioner 46. The paddle assembly depicted in FIGS. 4A-4D, is attached to the shaft 58 of the conditioner 46 through the use of an affixation collar 114. The collar 114 may be positioned within radially positioned slots 128 spaced along the shaft 58. The alternative paddle assembly generally includes triangular shaped supports 116 having semi-circular shaped cutouts 118 proximate to a base 120. The paddle supports 116 also include a plurality of bolt receiving apertures 122 which may be used to secure the paddle supports 116 to the collar 114. Bolts and nuts as positioned through the aligned apertures 122 of the collar 114 and the supports 116 may be used to secure the supports 116 to the collar 114. The collar 114 generally encircles the shaft 58.

As may be seen in FIGS. 4A-4D, the alternative paddle supports 116 are generally offset 90° relative to each other along the length of the shaft 58. The paddle supports 116 are also generally aligned on opposite sides of the shaft 58. A first pair of paddle supports 116 may be positioned at the 0° and 180° locations and the second pair of paddle supports may be positioned at the at the 90° and 270° locations relative to the shaft 58.

A paddle face 124 may be secured to, and traverse between a pair of adjacent paddle supports 116. The paddle faces 124 are preferably angularly offset with respect to the paddle supports as earlier described with respect to the paddle faces 112 and paddle supports 74. In this embodiment the paddle faces 124 are elongate and function as a bridge between a pair of adjacent paddle supports 116. The paddle faces 124 may be releasably secured to the paddle supports 116 or alternatively may be fixedly secured to the paddle supports 116 through welding of other permanent affixation mechanisms.

Generally the paddle faces 124 are securely attached to the paddle supports 116 at the top, or opposite to the semi-circular cutouts 118. However, in alternative embodiments, the paddle faces 124 may be attached or releasably secured to extend horizontally between a pair of adjacent paddle supports 116 at any desired vertical location. Further in alternative embodiments the paddle faces 124 may completely or substantially cover the area between adjacent paddle supports 116. In the alternative embodiment depicted in FIGS. 4A-4D, the paddle faces 124 are generally rectangular pieces of metal which are positioned for fixed attachment to the top of a pair of adjacent paddle supports 116. Each of the pair of adjacent paddle supports 116 may include a receiving channel or slot 126 which is preferably adapted to securely receive a paddle face 124.

The conditioner 46 generally includes a working chamber having a uniform diameter. The conditioner 46 may alternatively have a working chamber formed of sections of larger or smaller diameter. Within each of the sections of larger or smaller diameter the length dimension for the paddle supports 116 is required to be adjusted for the positioning of the paddle faces 124, 112 proximate to the interior surface of the working chamber. It is generally contemplated that a single shaft 58 will be utilized, however the shaft 58 may alternatively be formed of shaft sections.

In an alternative embodiment, the third shaft 58 may be divided into two independent shafts. Each of the independent third shafts 58 may be rotated by third motors 56. The independent third shafts 58 in this embodiment are not required to be aligned and/or to rotate at identical rotations per minute. Alternatively, two motors may be connected to a single third shaft 58 for rotation within the conditioner 46. In the embodiment utilizing more than one third shaft 58, bushings and/or bearings are preferably positioned for support and engagement to the respective drive shafts 58 to facilitate rotation inside of the conditioner 46. The rotation of the independent third drive shafts 58 is therefore not required to be synchronized and/or identical in speed within the conditioner 46. Generally, a single third shaft reduces risk of shaft deflection which may occur during rotation at certain speeds, which may vary dependent upon the length of the shaft. However, when the longitudinal dimension for the conditioner 46 increases, it may be preferable to incorporate a dual drive shaft embodiment to reduce shaft deflection especially during rotation at increased speeds.

The shaft 58 may include uniformly sized and shaped paddles 64. Alternatively, the shaft 58 may include paddles 64 as depicted in FIG. 4A. In an alternative embodiment the shaft 58 may include a combination of alternative styles of paddles 64 at the discretion of an individual. The combinations as to the size and/or style of paddles 64 utilized on the shaft 58 within the conditioner 46 are potentially infinite.

The third drive motor 56 rotates the drive shaft 58 and therefore the paddles 64 at a rotational rate between approximately 15 and 250 rotations per minute. The drive motor 56 may be any type of drive mechanism known and may engage the drive shaft 58 by belt, chain, gears, hydraulic or other means. The rotating action of the paddles 64 within the conditioner 46 forces the particulate feed 48 radially outward causing the majority of the particulate to forcibly contact the interior wall of the chamber of the conditioner 46, and the paddles 64, thereby reducing the particulate feed 48 into a refined condition, whereupon a desired percentage of the starch included within the feed particulate is gelatinized. Gelatinization of the feed is accomplished through a combination of pressure, moisture, steam, temperature, and forcible contact to the paddles adjacent to the wall of the chamber of the conditioner 46. The continuous pressurized conditioner 10 provides superior quality feed having improved gelatinization of the available starch to approximately 32% to 46%. The processed feed provides for superior raw material for pelletizing of improved quality feed pellets for use particularly with turkeys and ducks.

Generally, the factors manipulated to effectuate the gelatinization of the starch of the raw feed material include the control of the time of processing which occurs by regulating the size of the pressurized conditioner 46, the positioning of the retention paddles 64, and the rotations per minute of the shaft rotor 58. In addition, the control of the temperature occurs by regulating the internal working steam pressure for the conditioner 46, and the second pressurized tube feeder 70 where steam is injected into the conditioner 46 to increase pressure and heat exposed to the product. Further, the moisture level is controlled by regulating the combination of live stem injection as well as water introduced from the water nozzles.

Generally, the moisture level for the processed feed exiting the second pressurized tube feeder 70 is between 14% and 18% prior to pelletizing. Processed feed should be fed directly to the pellet mill maintaining the temperature and moisture content for the processed feed. If the feed is allowed to cool to a temperature below 200° F. or moisture is permitted to evaporate to approximately 13% or lower, then the pellet quality substantially decreases and the percentage of fines versus pellets substantially increases. Generally, the method for processing feed described herein results in the gelatinizing of starch at a level of approximately 44% for corn processed at a pressure of 10 lbs. per square inch; 42.9% at corn processed at a pressure of 7 lbs. per square inch; and 34.5% for corn processed at a pressure of 5 lbs. per square inch.

The angular separation between adjacent paddle supports 74 along the third shaft 58; the angular offset of the paddle faces 112, 124, relative to a paddle supports 74, 116, and the rate of rotation of the third shaft 58 by the third motor 56 affects the time of retention or processing of the feed material 48 within the conditioner 46. Generally the period of time for processing of the feed material 48 within the conditioner 46 is approximately one minute. The length of time for processing of the feed material 48 within the conditioner 46 may also be increased or decreased dependent upon the level of gelatinization desired for the starch within the feed material 48.

Within the interior of the conditioner 46 the plurality of longitudinally mounted radially extending third paddles 64 rotate forcing the air stream along the chamber and forcing the air stream to circulate in a manner similar to a continuous mixer. This mixing effect causes the feed material 48 break apart and to particulate inside the chamber. The circulating third paddles 64 have a unique configuration such that when rotating at speed, the paddles 64 provide the desired mixing effect upon the air stream, without subjecting the air stream to disruptive turbulence. In addition, the third paddles' 64 design is such that particulate tends not to collect or build up on the paddle surface and/or paddle face 112, 124. The rotating action of the third paddles 64 directs the particulate matter longitudinally as represented by arrow 76 toward the third exit port 68 which is opposite the main inlet area 54 within the chamber for the conditioner 46. The third exit port 68 is generally open allowing the processed particulate matter to drop out of the chamber and the conditioner 46 and into the inlet port 80 for the second pressurized tube feeder 70. The generally open communication between the conditioner 46, the exit port 68, and the inlet port 80 prevents build up of particulate matter within the conditioner 46.

During processing, the raw feed material 48 as entering the conditioner 46 is exposed to steam, and/or injected steam from the steam inlet port 50 and may be exposed to moisture in the form of water and/or other pre-mixed additive liquids to adjust the moisture level of the raw feed material 48 to between 14% and 18%. Generally, the raw feed material 48 entering the mixer/feeder 12 has a starting moisture content of below 13%. The exposure of the raw feed material 48 to steam from the steam inlet port 58, in conjunction with the pressure established by operation of the conditioner 46, increases the temperature of the raw feed material 48 to between 205° F. and 240° F. Steam enters the conditioner 46 through one or more steam inlet and/or injection nozzles and liquid enters the conditioner 46 through one or more liquid inlet and/or injection nozzles. The paddles 64 mix air and the steam and/or liquid with the raw feed material 48 to initiate reduction of the feed to particulate matter. During the reducing process, particulate feed may be encapsulated and/or jacketed in steam and/or water or other liquids.

The liquid added to the conditioner 46 for exposure to the particulate feed may include one or more odor masking chemicals, nutrients, additives, or other veterinary treatments for incorporation into a pelletized consumable feed.

The conditioner 46 may also include one or more moisture accumulation areas which may be periodically opened to remove moisture from the interior of the conditioner 46. Alternatively, excess moisture may be accumulated for recycling back to the liquid inlet port 52.

As may be seen in FIG. 1, the second pressurized tube feeder 70 is preferably in communication with the exit port 68 of the conditioner 46. The second pressurized tube feeder 70 is preferably positioned proximate to and/or in communication with the conditioner 46. The operation of the conditioner 46 preferably creates sufficient pressure to outwardly force particulate feed into the second pressurized tube feeder 70. In general, the second pressurized tube feeder 70 creates a second plug of particulate feed 96 proximate to the tapered cone/discharge block 98. The second pressurized tube feeder 70 and the second plug 96 facilitate to retain pressure upon the particulate feed and to minimize loss of pressure either downstream through the discharge block 98 or upstream through the conditioner 46.

The second pressurized tube feeder 70 preferably has a fourth inlet port 80. The second pressurized tube feeder 70 may be formed of a pressurized casing 82. Interior to the pressurized casing 82 is preferably located a fourth shaft 84. The fourth shaft 84 is preferably engaged to a fourth motor 86. The fourth motor 86 generally rotates the fourth shaft 84 at a rate of between 16 and 70 rotations per minute. The fourth shaft 84 is also preferably engaged to a fourth single bearing 88. Opposite to the fourth single bearing 88 is preferably the fourth open end or discharge port 90. A second auger/screw 92 is preferably engaged in surrounding engagement to the fourth shaft 84. The second auger/screw 92 is generally of sufficient size to be proximate to and/or in contact with the inside of the pressurized casing 82. The second auger/screw 92 generally terminates approximately 1½ flights prior to the fourth open end/discharge port 90. The termination of the second screw 92 approximately 1½ flights prior to the fourth discharge port 90 and the discharge block 98 establishes a collection area where particulate matter may accumulate to form the solid second plug 96 of continually advancing particulate feed matter. Processed particulate feed product passes through the second pressurized tube feeder 70 in the direction of arrow 94, whereupon, a second plug 96 of processed feed accumulates proximate to the fourth open end/discharge port 90.

The second pressurized tube feeder 70 in conjunction with the second auger/screw 92 facilitates the formation of the second plug 96, and an air seal and/or air lock for the continuous pressurized conditioner 10. Generally, during operation the second plug 96 is advanced and simultaneously maintained by the continuous build-up of particulate matter behind the advancing second plug 96. By plugging the discharge port 90 in this manner, the system is able to maintain a desired amount of pressure without release of pressure upstream through the conditioner 46 or downstream past the discharge block 98. The matter which comprises the second plug 96 is continuously pushed to the fourth discharge port 90 and replaced by material that follows, thus assuring that no static material remains in the system. Pressure is preferably maintained within the second pressurized tube feeder 70 at between 5 lbs. per square inch to 10 lbs. per square inch.

The formation of the second plug 96 functions as an air lock to prevent pressure loss outwardly from the second pressurized tube feeder 70 while simultaneously maintaining a reverse air block preventing entry of air into the second pressurized tube feeder 70 and past the discharge block 98 when the discharge block 98 is forced outwardly from the fourth open discharge port 90. The second plug 96 insures that air is prevented from entering the system while simultaneously insuring that pressure is not lost outwardly from the second pressurized tube feeder 70. The second plug 96 thereby allows pressure to be maintained within the second pressurized tube feeder 70 and conditioner 46 during feed processing.

Generally, it is desirable to establish a rate of rotation for the fourth shaft 84 of the second pressurized tube feeder 70 of sufficient speed to insure that particulate feed does not accumulate at the third inlet port 80 which could potentially clog the second pressurized tube feeder 70. It is desirable to have the fourth shaft 84 and the second pressurized tube feeder 70 rotate at an increased or sufficient rate in order to insure that the material is transported proximate to the fourth open end 90 to form the second plug 96 of processed and particulized feed material.

The tapered nose cone/discharge block 98 preferably comes to a point. The point is generally centered on the fourth open end 90 of the second pressurized tube feeder 70. The tapered nose cone/discharge block 98 is generally the same size as the fourth open end 90 of the second pressurized tube feeder 70. The angle of taper for the discharge block 98 is approximately 60 degrees.

The tapered nose cone/discharge block 98 is preferably positioned for sealing engagement within the fourth open end 90. The discharge block 98 is preferably connected to a fifth shaft 100. The fifth shaft 100 is preferably connected to a pressurized cylinder 102. The pressurized cylinder 102 facilitates the retention of the discharge block 98 within the fourth open end 90. Generally, the pressure within the second pressurized tube feeder 70 builds upon the second plug 96 until such time as the pressure upon the second plug 96 exceeds the force exerted by the pressurized cylinder 102, as holding the discharge block 98 within the fourth open end 90. When a sufficient amount of excess pressure has been built upon the second plug 96 by the second pressurized tube feeder 70, then the advancing second plug 96 will force the discharge block 98 toward the pressurized cylinder, permitting the discharge or extrusion of feed out of the fourth open end 94 dropping downwardly out of the fifth exit port 104. The feed 96 is generally extruded past the discharge block 98 and the fourth open end 90 when the pressure upon the second plug 96 exceeds the force exerted by the pressurized cylinder 102. When a sufficient amount of pressure has been released from the interior of the second pressurized tube feeder 70, then the force of the pressurized cylinder 102 upon the discharge block 98 will exceed the outward pressure of the second plug 96 causing the discharge block 98 to be forced in a direction opposite to arrow 94, for insertion and sealing engagement of the discharge block 98 into the fourth open end 90. The discharge feed cycle through the fourth open end 90 will continue upon accumulation of sufficient pressure upon the second plug 96 to repeat the discharge or extrusion of feed cycle.

The pressurized cylinder 102 generally exerts approximately 5 lbs. to 15 lbs. per square inch of pressure against the discharge block 98 and the fourth open end 90. Generally as the steam pressure within the conditioner 46 and the second pressurized tube feeder 70 is increased between the 5 lbs. to 10 lbs. per square inch range, then the pressure exerted by the pressurized cylinder 102 on the nose cone/discharge block 98 is likewise required to be increased within the 5 lbs. to 15 lbs. per square inch of pressure range.

The discharge block 98 may be conical in shape and is sized for sealing engagement within the fourth open end 90 of the second pressurized tube feeder 70. The discharge block 98 preferably is forced outwardly from the fourth open end 90 into the interior of a transition chamber 130. The transition chamber 130 preferably includes the fifth exit port 104 which is preferably in communication with a lump breaker 106. The discharge block 98 may include a sealing lip 132 which is preferably adapted for sealing engagement to the exterior surface of the fourth open end 90 of the second pressurized tube feeder 70. The transition chamber 130 may include an access cover 134 which may provide an opening for cleaning and/or service to be provided to the discharge block 98.

The discharge block 98 may be formed of any materials desired by an individual including, but not necessarily limited to the use of, plastics, aluminum, stainless steel, and/or any other type of metal. Preferably, the material selected for the discharge block 98 is selected to minimize accumulation of particulate feed upon the discharge block 98, to facilitate the downward crumbling of the advancing second plug 96 of feed material through the fifth exit port 104 for processing by the lump breaker 106.

Below the fifth exit port 104 and/or in feed flow communication with the fifth exit port 104 is preferably a lump breaker 106. The lump breaker 106 may be any device which reduces the processed feed to a sufficient size and quality for pelletizing within a pelletizer 108. The lump breaker may take the form of the devices as disclosed within U.S. Pat. Nos. 6,248,156; 5,526,988; 3,973,735; 4,767,066; 4,076,177; 4,830,291; 5,062,575; 4,131,247; 5,887,808; and/or 5,271,163 all of which are incorporated by reference herein in their entireties. Following passing through the lump breaker 106, the feed is preferably pelletized by a pelletizer as is known in the art.

Generally, the components of the mixer/feeder 12, first tube feeder 16, conditioner 46, pressurized screw 70, discharge block 98, lump breaker 106, and pelletizer 108 are in communication through the use of quick release coupling mechanisms to facilitate disassembly and cleaning and/or replacement of individual units as desired.

The normal pelletizing processes as known in the art generally result in the production of 20 to 35% fines as a ratio of fines to pellets where pellets generally have a pellet durability index of 55 as manufactured through the use of a Kahl expander. Normal gelatinization when feed is processed within an expander is approximately 25% of the corn starch.

The continuous pressurized conditioner system 10 and methodology herein reduces fines to approximately 1½% to 3% as a ratio of fines to pellets during the pelletization process, where the pellets have a pellet durability index of approximately 89 to 92 when pelletization processes are commenced immediately following exit from the continuous pressurized conditioner 10. The continuous pressurized conditioner system 10 gelatinizes approximately 34.5% to 44% of the corn starch present in the raw feed material. On average, the percent of gelatinization of the starch during the use of the continuous pressurized conditioner system 10 is 40.466% with an average level of fines of 2.5% and an average pellet durability index of 90.4%.

Generally, fines resulting from the pelletization process should be screened off from the pellets and returned to the pellet mill for further processing to avoid minimization of waste of resources.

### EXAMPLES

In one example, the mixer/feeder 12 was set to introduce 2600 lbs. of raw feed material per hour. The third shaft 58 within the conditioner 46 was set to rotate the paddles 64 at a rate of 220 rotations per minute. The fourth shaft 84 of the second pressurized tube feeder 70 was set to rotate the auger/second screw 92 at a rate of 24 rotations per minute. Pressure was maintained within the conditioner 46 and the second pressurized tube feeder 70 at a level between 5 lbs. and 10 lbs. per square inch. The pressurized cylinder 102 as attached to the tapered cone/discharge block 98 was set at 50 lbs. per square inch.

The raw feed entering the mixer/feeder 12 had a moisture content of 13.7% and was at ambient temperature. No water was added to the feed during processing by the continuous pressurized conditioner 10. Steam was applied to raise the moisture level of the feed to 14.6% and the product temperature up to 228° F. The pellet density index for pellets formed according to the above-described methodology was 89% to 90.2%, and the percent fines was determined to be 2.6%.

In another example, the mixer/feeder 12 was set to introduce 2000 lbs. of raw feed material per hour. The third shaft 58 within the conditioner 46 was set to rotate the paddles 64 at a rate of 220 rotations per minute. The fourth shaft 84 of the second pressurized tube feeder 70 was set to rotate the auger/second screw 92 at a rate of 24 rotations per minute. Pressure was maintained within the conditioner 46 and the second pressurized tube feeder 70 at a level of 7 lbs. per square inch. The pressurized cylinder 102 as attached to the tapered cone/discharge block 98 was set at 50 lbs. per square inch.

The raw feed entering the mixer/feeder 12 had a moisture content of 13.7% and was at ambient temperature. No water was added to the feed during processing by the continuous pressurized conditioner 10. Steam was applied to raise the moisture level of the feed to 14.6% and the product temperature up to 228° F. The pellet density index for pellets formed according to the above-described methodology was 89% to 90.2% and the percent fines was determined to be 2.6%. The total percent of starch of feed material was initially determined to be approximately 60%. Following processing according to the above-identified methodology, the total percent of gelatinized starch was determined to be 42.9% and the total starch which was not gelatinized was 17.1%.

In another example, the mixer/feeder 12 was set to introduce 2600 lbs. of raw feed material per hour. The third shaft 58 within the conditioner 46 was set to rotate the paddles 64 at a rate of 220 rotations per minute. The fourth shaft 84 of the second pressurized tube feeder 70 was set to rotate the auger/second screw 92 at a rate of 24 rotations per minute. Pressure was maintained within the conditioner 46 and the second pressurized tube feeder 70 at a level between 5 lbs. and 10 lbs. per square inch. The pressurized cylinder 102 as attached to the tapered cone/discharge block 98 was set at 50 lbs. per square inch.

The raw feed entering the mixer/feeder 12 had a moisture content of 13.7% and was at ambient temperature. In this example water was added to the feed within the conditioner 46 at a rate of 9 gallons per hour. Steam was applied to raise the temperature of the product to 220° F. The water and steam in combination increased the moisture level of the particulate feed to 17.2%. The pellet density index for the pellets formed according to the above-described methodology was 91% and the percent fines was 1.5%.

In another example, the mixer/feeder 12 was set to introduce 1000 lbs. of raw feed material per hour. The third shaft 58 within the conditioner 46 was set to rotate the paddles 64 at a rate of 220 rotations per minute. The fourth shaft 84 of the second pressurized tube feeder 70 was set to rotate the auger/second screw 92 at a rate of 24 rotations per minute. Pressure was maintained within the conditioner 46 and the second pressurized tube feeder 70 at a level of 10 lbs. per square inch. The pressurized cylinder 102 as attached to the tapered cone/discharge block 98 was set at 50 lbs. per square inch.

The raw feed entering the mixer/feeder 12 had a moisture content of 13.7% and was at ambient temperature. In this example, water was added to the feed within the conditioner 46 at a rate of 9 gallons per hour. Steam was applied to raise the temperature of the product to 220° F. The water and steam in combination increased the moisture level of the feed to be pelletized to be 17.2%. The pellet density index for the pellets formed according to the above-described methodology was 91% and the percent fines was 1.5%. The total percent of starch of the feed material was initially determined to be approximately 58.2%. Following processing according to the above-identified methodology, the total percent of gelatinized starch was determined to be 44%, and the total starch which was not gelatinized was 14.2%.

In another example the mixer/feeder 12 was set to introduce 2600 lbs. of raw feed material per hour. The third shaft 58 within the conditioner 46 was set to rotate the paddles 64 at a rate of 220 rotations per minute. The fourth shaft 84 of the second pressurized tube feeder 70 was set to rotate the auger/second screw 92 at a rate of 24 rotations per minute. Pressure was maintained within the conditioner 46 and the second pressurized tube feeder 70 at a level between 5 lbs. and 10 lbs. per square inch. The pressurized cylinder 102 as attached to the tapered cone/discharge block 98 was set at 50 lbs. per square inch.

The raw feed entering the mixer/feeder 12 had a moisture content of 13.7% and was at ambient temperature. In this example, water was added to the feed within the conditioner 46 at a rate of 12 gallons per hour. Steam was applied to raise the temperature of the product to 220° F. The water and steam in combination increased the moisture level of the feed to be pelletized to be 18.4%. The pellet density index for the pellets formed according to the above-described methodology was 91.4% and the percent fines was 3.2%.

In another example, the mixer/feeder 12 was set to introduce 3000 lbs. of raw feed material per hour. The third shaft 58 within the conditioner 46 was set to rotate the paddles 64 at a rate of 220 rotations per minute. The fourth shaft 84 of the second pressurized tube feeder 70 was set to rotate the auger/second screw 92 at a rate of 24 rotations per minute. Pressure was maintained within the conditioner 46 and the second pressurized tube feeder 70 at a level of 5 lbs. per square inch. The pressurized cylinder 102 as attached to the tapered cone/discharge block 98 was set at 50 lbs. per square inch.

The raw feed entering the mixer/feeder 12 had a moisture content of 13.7% and was at ambient temperature. In this example, water was added to the feed within the conditioner 46 at a rate of 12 gallons per hour. Steam was applied to raise the temperature of the product to 220° F. The water and steam in combination increased the moisture level of the feed to be pelletized to be 18.4%. The pellet density index for the pellets formed according to the above-described methodology was 91.4% and the percent fines was 3.2%. The total percent of starch of the feed material was initially determined to be approximately 59.8%. Following processing according to the above-identified methodology, the total percent of gelatinized starch was determined to be 34.5%, and the total starch which was not gelatinized was 25.3%.

In another example, the mixer/feeder 12 was set to introduce 2600 lbs. of raw feed material per hour. The third shaft 58 within the conditioner 46 was set to rotate the paddles 64 at a rate of 220 rotations per minute. The fourth shaft 84 of the second pressurized tube feeder 70 was set to rotate the auger/second screw 92 at a rate of 24 rotations per minute. Pressure was maintained within the conditioner 46 and the second pressurized tube feeder 70 at a level of 6 lbs. per square inch. The pressurized cylinder 102 as attached to the tapered cone/discharge block 98 was set at 50 lbs. per square inch.

The raw feed entering the mixer/feeder 12 had a moisture content of 12.6% and was at ambient temperature. No water was added to the feed during processing by the continuous pressurized conditioner 10. Steam was applied to raise the moisture level to 14.9% and the product temperature up to 214° F. The pellet density index for pellets formed according to the above-described methodology was 92.5% and the percent fines was 2%.

In another example, the mixer/feeder 12 was set to introduce 2600 lbs. of raw feed material per hour. The third shaft 58 within the conditioner 46 was set to rotate the paddles 64 at a rate of 220 rotations per minute. The fourth shaft 84 of the second pressurized tube feeder 70 was set to rotate the auger/second screw 92 at a rate of 24 rotations per minute. Pressure was maintained within the conditioner 46 and the second pressurized tube feeder 70 at a level 6 lbs. per square inch. The pressurized cylinder 102 as attached to the tapered cone/discharge block 98 was set at 50 lbs. per square inch.

The raw feed entering the mixer/feeder 12 had a moisture content of 12.6% and was at ambient temperature. In this example, water was added to the feed within the conditioner 46 at 1.5%. Steam was applied to raise the temperature of the product to 214° F. The water and steam in combination increased the moisture level of the feed to be pelletized to 16.4%. The pellet density index for the pellets formed according to the above-described methodology was 92.5% and the percent fines was 1.5%.

In another example, the mixer/feeder 12 was set to introduce 2000 lbs. of raw feed material per hour. The third shaft 58 within the conditioner 46 was set to rotate the paddles 64 at a rate of 220 rotations per minute. The fourth shaft 84 of the second pressurized tube feeder 70 was set to rotate the auger/second screw 92 at a rate of 16 rotations per minute. Pressure was maintained within the conditioner 46 and the second pressurized tube feeder 70 at a level of 8 lbs. per square inch. The pressurized cylinder 102 as attached to the tapered cone/discharge block 98 was set at 30 lbs. per square inch.

The raw feed entering the mixer/feeder 12 had a moisture content of 13.7% and was at ambient temperature. Steam was applied to raise the moisture level to between 16% and 18%and the product temperature to between 210° F. and 218° F. The pellets formed in this example had an acceptable pellet durability index value and ratio of fines to pellets.

In another example, the mixer/feeder 12 was set to introduce 2600 lbs. of raw feed material per hour. The third shaft 58 within the conditioner 46 was set to rotate the paddles 64 at a rate of 220 rotations per minute. The fourth shaft 84 of the second pressurized tube feeder 70 was set to rotate the auger/second screw 92 at a rate of 20 rotations per minute. Pressure was maintained within the conditioner 46 and the second pressurized tube feeder 70 at a level of 5 lbs. per square inch. The pressurized cylinder 102 as attached to the tapered cone/discharge block 98 was set at 40 lbs. per square inch.

The raw feed entering the mixer/feeder 12 had a moisture content of 12.2% and was at ambient temperature. Steam was applied to raise the moisture level to 15.7% and the product temperature to 205° F. The pellets formed in this example had an acceptable pellet durability index value and ratio of fines to pellets.

In another example, the mixer/feeder 12 was set to introduce 2600 lbs. of raw feed material per hour. The third shaft 58 within the conditioner 46 was set to rotate the paddles 64 at a rate of 220 rotations per minute. The fourth shaft 84 of the second pressurized tube feeder 70 was set to rotate the auger/second screw 92 at a rate of 20 rotations per minute. Pressure was maintained within the conditioner 46 and the second pressurized tube feeder 70 at a level of 6 lbs. per square inch. The pressurized cylinder 102 as attached to the tapered cone/discharge block 98 was set at 55 lbs. per square inch.

The raw feed entering the mixer/feeder 12 had a moisture content of 11.5% and was at ambient temperature. Steam was applied to raise the moisture level to 15.4% and the product temperature to 215° F. The pellets formed in this example had an acceptable pellet durability index value and ratio of fines to pellets.

In another example, the mixer/feeder 12 was set to introduce 2600 lbs. of raw feed material per hour. The third shaft 58 within the conditioner 46 was set to rotate the paddles 64 at a rate of 220 rotations per minute. The fourth shaft 84 of the second pressurized tube feeder 70 was set to rotate the auger/second screw 92 at a rate of 20 rotations per minute. Pressure was maintained within the conditioner 46 and the second pressurized tube feeder 70 at a level of 8 lbs. per square inch. The pressurized cylinder 102 as attached to the tapered cone/discharge block 98 was set at 65 lbs. per square inch.

The raw feed entering the mixer/feeder 12 had a moisture content of 11.5% and was at ambient temperature. Steam was applied to raise the moisture level to 14.3% and the product temperature to 218° F. to 220° F. The pellets formed in this example had an acceptable pellet durability index value and ratio of fines to pellets.

The above disclosure is intended to be illustrative and not exhaustive. This description will suggest many variations and alternatives to one of ordinary skill in this art. All these alternatives and variations are intended to be included within the scope of the claims where the term “comprising” means “including, but not limited to”. Those familiar with the art may recognize other equivalents to the specific embodiments described herein which equivalents are also intended to be encompassed by the claims.

Further, the particular features presented in the dependent claims can be combined with each other in other manners within the scope of the invention such that the invention should be recognized as also specifically directed to other embodiments having any other possible combination of the features of the dependent claims. For instance, for purposes of claim publication, any dependent claim which follows should be taken as alternatively written in a multiple dependent form from all prior claims which possess all antecedents referenced in such dependent claim if such multiple dependent format is an accepted format within the jurisdiction (e.g. each claim depending directly from claim 1 should be alternatively taken as depending from all previous claims). In jurisdictions where multiple dependent claim formats are restricted, the following dependent claims should each be also taken as alternatively written in each singly dependent claim format which creates a dependency from a prior antecedent-possessing claim other than the specific claim listed in such dependent claim below (e.g. claim 3 may be taken as alternatively dependent from claim 2; claim 4 may be taken as alternatively dependent on claim 2, or on claim 3; claim 6 may be taken as alternatively dependent from claim 5; etc.).

This completes the description of the preferred and alternate embodiments of the invention. Those skilled in the art may recognize other equivalents to the specific embodiment described herein which equivalents are intended to be encompassed by the claims attached hereto.

Having thus described the preferred embodiments in sufficient detail as to permit those of skill in the art to practice the present invention without undue experimentation, those of skill in the art will readily appreciate other useful embodiments within the scope of the claims hereto attached. For example, although the present invention has been described as useful for the feed pellet manufacturing industry, those of skill in the art will readily understand and appreciate that the present invention has substantial use and provides many benefits in other industries as well. In view of the foregoing descriptions, it should be apparent that the present invention represents a significant departure from the prior art in construction and operation. However, while particular embodiments of the present invention have been described herein in detail, it is to be understood that various alterations, modifications and substitutions can be made therein without departing in any way from the spirit and scope of the present invention, as defined in the claims which follow.

In addition to being directed to the embodiments described above and claimed below, the present invention is further directed to embodiments having different combinations of the features described above and claimed below. As such, the invention is also directed to other embodiments having any other possible combination of the dependent features claimed below.

The above examples and disclosure are intended to be illustrative and not exhaustive. These examples and description will suggest many variations and alternatives to one of ordinary skill in this art. All these alternatives and variations are intended to be included within the scope of the attached claims. Those familiar with the art may recognize other equivalents to the specific embodiments described herein which equivalents are also intended to be encompassed by the claims attached hereto.

1. A pressurized conditioner apparatus comprising:
a substantially cylindrical first tube feeder having a first inlet and a first discharge end, the first tube feeder further having a transfer mechanism, said transfer mechanism constructed and arranged to transfer feed from said first inlet to said first discharge end, said transfer mechanism being further constructed and arranged to create a first plug of feed material within said first tube feeder proximate to said first discharge end;
a substantially cylindrical conditioner in feed flow communication with said first tube feeder, said conditioner having a drive shaft, the drive shaft having a plurality of radially projecting members which project into the conditioner, a drive source, the drive source engaged to the drive shaft, the drive source constructed and arranged to provide the drive shaft with a predetermined rate of rotation, said conditioner further having a steam inlet port, the steam inlet port constructed and arranged to allow steam to enter the conditioner, the conditioner further having a an exit port;
a substantially cylindrical second tube feeder in feed flow communication with said conditioner, said second tube feeder having an inlet port and an open end discharge port, the second tube feeder further having a second transfer mechanism, said second transfer mechanism constructed and arranged to transfer said feed from said inlet port to said open end discharge port, said transfer mechanism being further constructed and arranged to create a second plug of feed material within said second tube feeder proximate to said open end discharge port;
a discharge block proximate to said open end discharge port, said discharge block being in feed flow obstructing communication with said open end discharge port, said discharge block being connected to an actuator, said actuator constructed and arranged to permit said discharge block to be moved proximate to and away from said open end discharge port; and
a feed pelletizer in feed flow communication with said discharge block, said feed pelletizer constructed and arranged to pelletize said feed.

2. The pressurized conditioner apparatus according to claim 1, the conditioner further comprising at least one liquid inlet port, the at least one liquid inlet port constructed and arranged to place liquid inside the conditioner, the plurality of radially extending members being constructed and arranged to mix at least a portion of the feed with the steam and the liquid thereby increasing a moisture level for said feed.

3. The pressurized conditioner apparatus according to claim 2, the second transfer mechanism comprising a rotatable screw having a plurality of flights, said flights terminating at least one flight away from said open end discharge port where the feed is allowed to accumulate thereby forming said second plug, said second plug being continuously advancing.

4. The pressurized conditioner apparatus according to claim 3, the plurality of radially extending members each comprising a support shaft and a paddle, the paddles having a face, the face being angled relative to the support shaft.

5. The pressurized conditioner apparatus according to claim 4, the drive source constructed and arranged to rotate the drive shaft at a rate in excess of 15 rotations per minute.

6. The pressurized conditioner apparatus according to claim 5, wherein the radially extending members are regularly spaced along said drive shaft, wherein said radially extending members adjacent to each other are angularly offset relative to each other.

7. The pressurized conditioner apparatus according to claim 6, further comprising a mixer in feed flow communication with said first tube feeder.

8. The pressurized conditioner apparatus according to claim 7, further comprising a lump breaker in feed flow communication between said discharge block and said feed pelletizer, said lump breaker constructed and arranged to process said feed prior to said pelletizer.

9. The pressurized conditioner apparatus according to claim 8, the first transfer mechanism comprising a rotatable screw having a plurality of flights, whereon rotation of said screw transfers feed for accumulation proximate to said first discharge end for establishment of said first plug, said first plug being continuously advancing.

10. The pressurized conditioner apparatus according to claim 9, said liquid being selected from the group consisting of water, vitamins, veterinarian treatments, nutritional supplements, a deodorizer, and masking chemicals or any combination thereof.

11. The pressurized conditioner apparatus according to claim 10, said discharge block comprising a tapered cone and said actuator comprising a pressurized cylinder.

12. A method for processing feed to be pelletized comprising the following steps:
introducing feed material into a first tube feeder;
passing the feed material within the first tube feeder towards a first discharge end for the formation of a first plug of feed material;
transferring the feed material into a conditioner for exposure of the feed material to rotating paddles, steam and pressure for processing;
introducing the processed feed material into a second tube feeder and passing the processed feed material to an open end discharge port for the formation of a second plug of feed material;
retractably blocking the open end discharge port through the use of a discharge block to assist in the formation of the second plug of feed material, to facilitate the retention of pressure within the second tube feeder and the conditioner; and
transferring the feed to a pelletizer.
